(19) United States
(12) Patent Application Publication
(10) Pub. No.: US 2016/0153911 A1
(43) Pub. Date: Jun. 2, 2016

(54) INSTANT VIEW OF PROTEIN BANDS

(71) Applicant: Yi WANG, Southbury, CT (US)

(72) Inventor: Yi WANG, Southbury, CT (US)

(21) Appl. No.: 14/904,258

(22) PCT Filed: Jul. 11, 2014
(86) PCT No.: PCT/US2014/046285

§ 371 Date: Jan. 11, 2016

Related U.S. Application Data
(60) Provisional application No. 61/845,157, filed on Jul. 11, 2013.

(51) Int. Cl. G01N 21/64; G01N 27/447

(52) U.S. Cl. CPC G01N 21/6428; G01N 27/44726; G01N 2021/6439; G01N 2201/062; G01N 2201/061

(57) ABSTRACT

Apparatus, reagents, pre-treated proteins and methods for dying proteins in electrophoresis run gels, and for instantly viewing such dyed protein samples in an electrophoresis gel. A protein mixing solution containing a fluorescence dye is mixed with a protein sample so that fluorescence dyes within the protein mixing solution conjugate to proteins within the protein sample. Prior to performing electrophoresis, the protein sample mixture containing fluorescence dyed proteins is introduced into an electrophoresis gel, whereby after performing electrophoresis on such gel, the fluorescence dyed proteins are visible in the gel without the need to removed such gel from its container or cassette holder.

### PRIORITY

This application claims priority to U.S. Provisional Application Ser. No. 61/845,157, filed Jul. 11, 2013 entitled “Instant View of Protein Bands” having attorney docket no. WANY100004000.

### TECHNICAL FIELD

The present invention is directed to gel electrophoresis, and in particular, to apparatus, reagents, pre-treated proteins and methods for instantly viewing protein samples in an electrophoresis gel.

### BACKGROUND ART

Gel electrophoresis is known for separating and purifying protein, peptide DNA, RNA, and a variety of electrically charged macromolecules for the study thereof, or as a preparative step for subsequent analytical procedures. For instance, gel electrophoresis is often used to separate and purify molecules for protein purity verification, protein identification, subsequent DNA sequencing, blotting procedures, mass spectrometry, PCR, RFLP, cloning, or other known techniques for further characterization.

Typically, an electrophoresis apparatus is assembled by providing a vertically or horizontally oriented gel between two plates separated by spacers for holding the gel. The gel may be a prefabricated gel, or it may be mixed by the user assembling the electrophoresis apparatus prior to use thereof. Once the gel is provided between the plates, a buffer solution is poured into reservoirs of the electrophoresis apparatus so that the buffer covers the gel while electrodes reside in the buffer solution. With the samples to be tested residing in wells of the gel, an electric current is applied to the assembly via the electrodes to generate an electric field across the gel for separating the charged molecules in such gel. The gel is then removed for subsequent analytical procedures.

Electrophoresis is an important method for protein analysis. After electrophoresis, electrophoresis run gels are often stained using colorants to visualize the protein samples therein. An often used colorant to stain protein is Coomassie blue, which is the name of two similar triphenylmethane dyes. These colorants are Coomassie Brilliant Blue G-250 and Coomassie Brilliant Blue R-250, both of which bind to proteins through ionic interactions between dye sulfonic acid groups and positive protein amine groups, as well as through Van der Waals attractions.

In functionality, Coomassie Blue R-250 is more sensitive than Coomassie Blue G-250, detecting as little as 0.1 μg of protein. However, the less sensitive Coomassie Blue G-250 provides a faster staining process as compared to its counterpart Coomassie Blue R-250 staining process. Yet, each of these prior art processes for visualizing electrophoresis run gel protein samples undesirably require the use of volatile organic solvents, and are time consuming often requiring numerous processing hours.

For instance, a standard run for Coomassie Blue R-250 may involve prefixing an electrophoresis run gel in a solution of 50% MeOH, 10% HoAC, 40% H₂O for a time period ranging from several minutes to overnight. After soaking, the gel is then stained in this solution using about 0.25% Coomassie Blue R-250 and allowed to sit for a period of about 2 to 4 hours so that the gel has a uniform blue color. Staining is complete when the gel is no longer visible in the dye solution. Prior to complete staining, the gel will appear as a lighter area against the dark staining solution. After all these hours, the gel must then be destained for another 4 to 24 hours in a solution of about 5% MeOH, 7.5% HOAC, and 87.5% H₂O, whereby bands begin to appear in about 1 to 2 hours, or more.

Another time consuming and environmentally unfriendly prior art staining process involves setting an electrophoresis run gel in a solution of 25% IPA, 10% HOAC in water for a period of about 30 to 60 minutes, followed by staining the gel in 10% acetic acid in water with about 60 mg/L of Coomassie Blue R-250. Even though stain bands may begin to appear in about 30 minutes, the gel must remain in this solution for an extended period of time until desired band intensity has been obtained. The gel must then be destained in a solution containing 10% acetic acid for 2 or more additional hours.

The less sensitive Coomassie Blue G-250 is also a time consuming process. The Coomassie Blue G-250 staining reagent must first be prepared by dissolving 0.2 g dye in 100 ml H₂O under heated conditions to about 50° C. The solution is allowed to cool, and then 100 ml 2N H₂SO₄ is added to the solution followed by incubating the solution at room temperature for 3 hours to overnight. After the incubation period, the solution is filtered, followed by adding 22.2 ml 10 N KOH and 28.7 g TCA to the solution which is then allowed to stand for more than 3 hours. The filtering process may be repeated depending upon processing results and conditions. After these lengthy time periods, the electrophoresis run gel is immersed in this solution, whereby bands may begin to appear within 15 minutes over several hours depending upon the desired band intensity and reactant sensitivity.

These prior art approaches of protein staining in electrophoresis run gel are time consuming requiring numerous processing steps and hours to perform such steps. They are also disadvantageous since such processes utilize toxic and/or environmentally unfriendly solvents and chemicals.

Accordingly, a need continues to exist for improved methods of staining proteins in electrophoresis run gels, methods for instantly viewing protein samples in an electrophoresis gel, as well as improved apparatus, reagents and enhanced starting materials that allow easy and fast viewing of protein samples in an electrophoresis gel, all while requiring minimal processing and handling steps that are time efficient and low cost.

### DISCLOSURE OF INVENTION

In one or more embodiments the invention is directed to methods for instantly viewing protein samples in an electrophoresis gel. The method includes providing a protein mixing solution containing a fluorescence dye, which may be a fluorescein-type dye or a rhodamine-type dye. A mixture containing fluorescence dyed proteins is generated by mixing a protein sample with the protein mixing solution so that fluorescence dyes within the protein mixing solution conjugate to proteins within the protein sample. The proteins may be unpurified proteins or purified proteins. Prior to performing electrophoresis, a portion of the mixture containing fluorescence dyed proteins is provided into a gel. After electrophoresis of the gel is performed, the fluorescence dyed proteins are visible in the gel prior to performing further processing steps on such gel. The fluorescence dyed proteins may be viewed in the gel using UV and/or LED.

In other embodiments, the invention is directed to methods for dying proteins for using electrophoresis. These methods include providing a protein mixing solution containing a fluorescence dye, and generating a mixture containing fluorescence dyed proteins by mixing a protein sample with the protein mixing solution so that fluorescence dyes within the protein mixing solution conjugate to proteins within the protein sample. The proteins within the protein sample are dyed with fluorescence and provided into an electrophoresis gel prior to performing electrophoresis so that after performing electrophoresis the fluorescence dyed proteins are visible in the electrophoresis gel using an illuminating device.

In still other embodiments the invention is directed to fluorescence dye solutions for using electrophoresis. These fluorescence dye solutions include a fluorescein-type dye or a rhodamine-type dye dissolved in an organic solvent in a concentration from 0.1 mg/ml to 20 mg/ml. The fluorescence dye solutions may be mixed prior to use thereof, or prefabricated mixture ready for use.

In one or more embodiments the invention is directed to sample treatment buffer solutions for using electrophoresis. These sample treatment buffer solutions include a mixture of buffer solution selected from the group consisting of a borate buffer, a phosphate buffer, and a carbonate buffer; Dithiothreitol (DDT); Ethylenediaminetetraacetic acid (EDTA); Sodium dodecyl sulfate (SDS); and Glycerol or Sucrose. The mixtures may have a pH ranging from 7-11. These sample treatment buffer solutions may also be mixed prior to use thereof, or prefabricated mixture ready for use.

In further embodiments, the invention is directed to a protein mixing solution that includes a fluorescence dye solution and a sample treatment buffer solution having a pH ranging from 7-11. The fluorescence dye solution includes a fluorescein-type dye or a rhodamine-type dye dissolved in an organic solvent in a concentration from 0.1 mg/ml to 20 mg/ml. The sample treatment buffer solution includes a mixture of buffer solution selected from the group consisting of a borate buffer, a phosphate buffer, and a carbonate buffer; Dithiothreitol (DDT); Ethylenediaminetetraacetic acid (EDTA); Sodium dodecyl sulfate (SDS); and Glycerol or Sucrose. The fluorescence dye solution is mixed with the sample treatment buffer solution in volume ratios ranging from 1:5 to 1:100.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIGS. 1-6 illustrate various comparative UV/LED and Coomassie Blue stained imaging results of electrophoresis run gels each having wells containing different types of fluorescence dyed proteins in accordance with the numerous embodiments of the invention.

FIG. 7 shows an image taken using an LED blue trans-illuminator illustrating an electrophoresis run gel containing various protein samples of fluorescence dyed proteins of the invention that have been LED imaged while the gel resides inside a gel cassette.

FIGS. 8A-B illustrate exemplary structures of various fluorescence dyes suitable for use in accordance with one or more embodiments of the invention.

### MODES FOR CARRYING OUT THE INVENTION

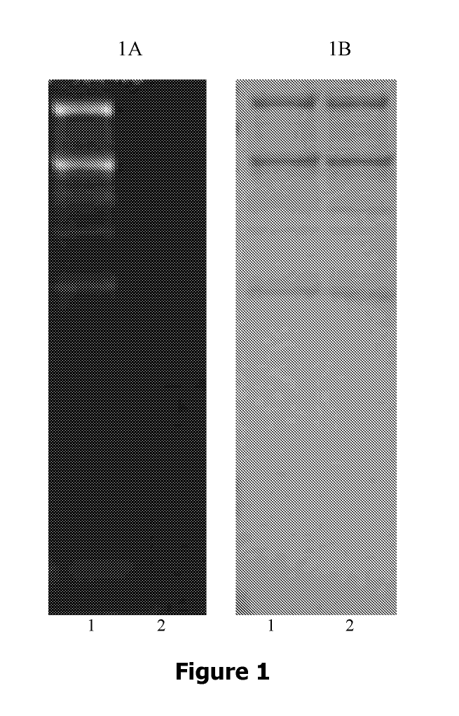

In describing the preferred embodiment of the present invention, reference will be made herein to FIGS. 1-9 of the drawings in which like numerals refer to like features of the invention.

The present invention is directed to apparatus, reagents, pre-treated proteins and methods for dying proteins in electrophoresis run gels and for instantly viewing such dyed protein samples in an electrophoresis gel. Various embodiments of the invention are also directed to apparatus, reagents and enhanced starting materials that allow easy and fast viewing of protein samples in an electrophoresis gel, all while requiring minimal processing and handling steps that are time efficient, environmentally friendly, and low cost.

In accordance with one or more embodiments of the invention, protein samples are treated prior to use in electrophoresis with a dye that allows direct viewing of the dyed protein samples. This direct viewing may be done using a standard laboratory UV and/or LED transilluminator, without the need to remove the gel from its electrophoresis tank or cassette. Suitable dyes for use in the invention are those that conjugate to the proteins to allow UV and/or LED viewing.

For instance, one or more embodiments of the invention utilize fluorescence dyes, such as, fluorescein-type dyes or rhodamine-type dyes. Suitable fluorescence dyes may include, but are not limited to: 5(6)-fluorescein isothiocyanate mixed isomer; 5/6-carboxyfluorescein succinimidyl ester; NHS-Rhodamine; 5(6)-tetramethyl-rhodamine isothiocyanate mixed isomer, 5/6-TRITC, TMR; Rhodamine B isothiocyanate; and any combination thereof.

In the process of treating protein samples with fluorescence dyes, a dye solution may be prepared by dissolving the selected dye in Dimethyl sulfoxide (DMSO) or Dimethylformamide (DMF). While the concentration of dye in solution may vary from 0.1 mg/ml to 20 mg/ml, in one or more preferred embodiments the final concentration of dye in solution ranges from about 1 mg/ml to about 10 mg/ml.

A sample treatment buffer is also prepared that does not containing an amine group. The buffer may include, but is not limited to, a borate buffer, phosphate buffer, carbonate buffer, and the like or mixtures thereof. The buffer preferably has a pH ranging from about 7-11, more preferably from about 8-10. In preparing the sample treatment buffer, the chosen non-amine containing buffer is mixed with one or more additional constituents. These compositions may include Dithiothreitol (DTT), Ethylenediaminetetraacetic acid (EDTA), Sodium dodecyl sulfate (SDS), Glycerol or Sucrose, Bromophenol blue, and any combination thereof.

In one or more embodiments the sample treatment buffer may include about 20-500 mM borate buffer or phosphate buffer with a pH ranging from about 7 to 11, about 2-8% DTT (preferably about 2-8% 20 mM DTT), about 0.1%-8% SDS (preferably about 2-4% SDS), about 0.1-0.5% EDTA (preferably about 0.1-0.5% 2 mM EDTA), about 4-50% glycerol (or sucrose to replace glycerol), and about 0.02% Bromophenol blue. The various sample treatment buffers encompassed by the invention include any combination of the foregoing constituents.

In accordance with the various embodiments, the dye solution and the sample treatment buffer may be mixed prior to use thereof, or preferably may be premade mixtures that are provided in kit form with the dye solution as a first solution (i.e., solution A) and the sample treatment buffer as a second solution (i.e., solution B). The invention encompasses the above various combinations of the sample treatment buffers in prefabricated or premade ready to use mixtures in kit forms.

The dye solution and sample treatment buffer are then mixed together to formulate a protein mixing solution. This protein mixing solution may be formulated by mixing the dye and sample treatment buffer solutions at various ratios ranging from 1:5 up to 1:100 (ratio by volume of solution A to solution B). In one or more preferred embodiments, the ratio of dye solution A to sample treatment buffer solution B includes volume ratios selected from 1:8, 1:16, or 1:32 to formulate the protein mixing solution (i.e., solution C). As with dye solution A and sample treatment buffer solution B, the invention also encompasses this protein mixing solution C as a prefabricated, or premade, ready to use mixture in kit form. As such, an end user may merely purchase solution A and solution B separately and mix them prior to use, or alternatively, these solutions A and B may be prefabricated as solution C whereby the end user simply purchases this protein mixing solution C for use.

The protein mixing solution C is then mixed with a desired protein sample that is to be analyzed using electrophoresis gel processing. The chemical compositions and formulations of the instant protein mixing solutions A, B and C may vary depending upon the properties and characteristics of the protein sample that is to be tested. While certain solutions are disclosed herein, it should be appreciated that various other chemical compositions and formulations are envisioned and encompassed within the scope of the present invention, whereby such solutions all allow a dye to conjugate to the proteins within the protein sample for direct viewing of the dyed protein samples within a gel processed and run through an electrophoresis process (i.e., an electrophoresis run gel). The selected dyes may allow viewing using UV and/or LED. The proteins and protein sample are treated with the protein mixing solution C prior to being provided within the gel and prior to the electrophoresis run (i.e., the proteins/protein samples are pre-treated prior to electrophoresis).

The protein mixing solution C may then be mixed with the desired protein sample that is to be run through gel electrophoresis processing, followed by further downstream processing. In accordance with one or more embodiments, the selected protein sample to protein mixing solution C may be mixed in volume ratios ranging from 1:1 up to 1:10. Once mixed, the combination solution is heated to temperatures ranging from about 70° C. to about 100° C. for about 2-30 minutes. It will be appreciated to one skilled in the art that in certain embodiments, depending upon the proteins and various solution reagents, the combined protein sample and protein mixing solution C may be heated to temperatures less than 70° C. and greater than 100° C. for durations less than 2 minutes to durations greater than 30 minutes.

After heating, the treated protein samples may be allowed to cool, and then loaded into wells of a gel used in electrophoresis processing. Once the desired amount of treated sample has been loaded into the gel wells, electrophoresis processing is performed and the then the electrophoresis run gel is place on an UV or LED trans-illuminator to view the protein bands and take pictures. The methods of the present invention avoid the time consuming processing steps of staining and destain associated with prior art techniques (e.g., Coomassie Blue staining processes), as well as avoid the use of toxic and/or dangerous chemicals associated with such prior art staining processes.

In accordance with various embodiments of the invention protein samples may be pretreated with an isothiocyanate derivative of rhodamine fluorescence dye or fluorescein dyes prior to electrophoresis to let the dye conjugate to the proteins residing within the protein sample. After processing in accordance with the invention, the dyed protein samples residing in wells of the gel may be viewed instantly with UV or LED—all while requiring no extensive gel staining and/or de-staining steps as in the prior art. The excess dye molecules migrate to the front of the gel, thereby leaving a clean background. Because both excitation and emission wavelengths of the dyes of the invention are within visible range, the protein bands can be viewed by a UV or LED blue transilluminitor without the need to remove gel from the electrophoresis tank or gel cassette. It has been found that the dye does not alter the protein sample migration pattern in the electrophoresis processing steps, as compared to protein samples not treated with the dye and/or dye solutions of the invention. As shown in the FIGS. 1-7, it has also been found that the present methods are just as sensitive, and in certain instances even more sensitive, than Coomassie Blue staining processes.

The methods and dye treated proteins of the invention may also be used for further downstream processing after the electrophoresis run and after UV and/or LED viewing. For instance, the dyed pre-treated protein samples of the invention may be subsequently stained/de-stained in accordance with known staining techniques such as, for example, Coomassie Blue staining techniques. Alternatively, the dyed pre-treated protein samples of the invention may be subsequently transferred to a membrane for Western blot experiment.

The present invention is directed to apparatus, reagents, pre-treated proteins and methods for dying proteins prior to electrophoresis run gels and for instantly viewing such stained protein samples in the electrophoresis gel while the gel remains within its cassette. Various embodiments of the invention are also directed to apparatus, reagents and enhanced starting materials that allow easy and fast viewing of protein samples in an electrophoresis gel, all while requiring minimal processing and handling steps that are time efficient, environmentally friendly, and low cost.

Various embodiments of the invention may be understood by way of the following examples and experimental results of the invention. The method of the invention may be applied to natural unpurified protein mixtures, as well as purified proteins. The results of these experiments and examples are shown in FIGS. 1-7.

Example 1: The Dye Solution A includes a fluorescein-type dye, comprising 5(6)-fluorescein isothiocyanate mixed isomer (CAS No. 27072-45-3), dissolved in Dimethyl sulfoxide (DMSO) to final concentration of dye of about 1 mg/ml. The DMSO may be alternated with Dimethylformamide (DMF).

The Sample Treatment Buffer Solution B includes 200 mM Phosphate buffer, pH 7.8; 20 mM Dithiothreitol (DTT); 2 mM Ethylenediaminetetraacetic acid (EDTA); 4% Sodium dodecyl sulfate (SDS); 4% Glycerol (can use sucrose to replace glycerol) and 0.02% Bromophenol blue. The Protein Mixing Solution C includes mixing the Dye Solution A to Sample Treatment Buffer Solution B in a ratio of 1:16 (by volume).

The protein sample is then mixed with the Protein Mixing Solution C to a ratio of 1:1 (by volume), and then heated at about 70° C.-100° C. for about 5-30 minutes. The protein sample may be a supernatant of E. Coli cell lysate with an over expressed protein. The volume ratio of solution C to protein sample can vary from 1:1 up to 1:10. The mixture may be cooled to render dye treated proteins and protein sample of the invention. Desired amounts of dye treated protein sample are loaded into wells of an electrophoresis gel (e.g., an SDS-polyacrylamide gel), and the electrophoresis process performed according to common protocol.

After electrophoresis is complete, while still in the tank or gel cassette, the gel is placed on a UV trans-illuminator or a LED trans-illuminator to view the protein bands. Referring to FIG. 1, Image 1A is shown on the left side of page, which shows in Lane 1 thereof fluorescein-type dye treated (i.e., pretreated) proteins of the invention illuminated using a UV trans-illuminator. Lane 2 of Image 1A shows imaged results of the same supernatant protein sample, however, this sample did not include fluorescence dye treated proteins of the invention. That is, the imaged proteins in Lane 2, Image 1A, were not pre-treated with fluorescence dyes in accordance with the invention. As is shown in Image 1A, the fluorescence dye treated proteins in Lane 1 are clearly visible using UV, as compared to the non-treated/untreated proteins in Lane 2 thereof.

Following viewing of the fluorescence dyed proteins in gel wells of the invention, the gel from Image 1A was stained and de-stained through Coomassie Blue staining techniques, and the results shown in Image 1B of FIG. 1. As shown the proteins are visible in both Lanes 1 and 2 of Image 1B, such that, the results evidence that the fluorescence dyes do not deleteriously affect the proteins for further downstream processing. The bands shown in Lanes 1 and 2 of Image 1B are clear and visible, both with similar (if not the same) intensity.

Example 2: The Dye Solution A includes a Rhodamine-type dye, comprising NHS-Rhodamine (CAS No. 246256-50-8), dissolved in Dimethyl sulfoxide (DMSO) to final concentration of dye of about 1 mg/ml. The DMSO may be alternated with Dimethylformamide (DMF).

The Sample Treatment Buffer Solution B includes 200 mM borate buffer, pH 8.6; 20 mM DTT; 2 mM EDTA; 4% SDS; 4% Glycerol (can use sucrose to replace glycerol) and 0.02% Bromophenol blue. The Protein Mixing Solution C includes mixing the Dye Solution A to Sample Treatment Buffer Solution B in a ratio of 1:16 (by volume).

The protein sample is then mixed with the Protein Mixing Solution C to a ratio of 1:1 (by volume), and then heated at about 70° C.-100° C. for about 5-30 minutes. The protein sample may be a supernatant of mixed proteins. After cooling, dye treated proteins and protein sample of the invention are loaded into wells of an electrophoresis gel (e.g., an SDS-polyacrylamide gel) in desired amounts. The electrophoresis process is performed according to common protocol.

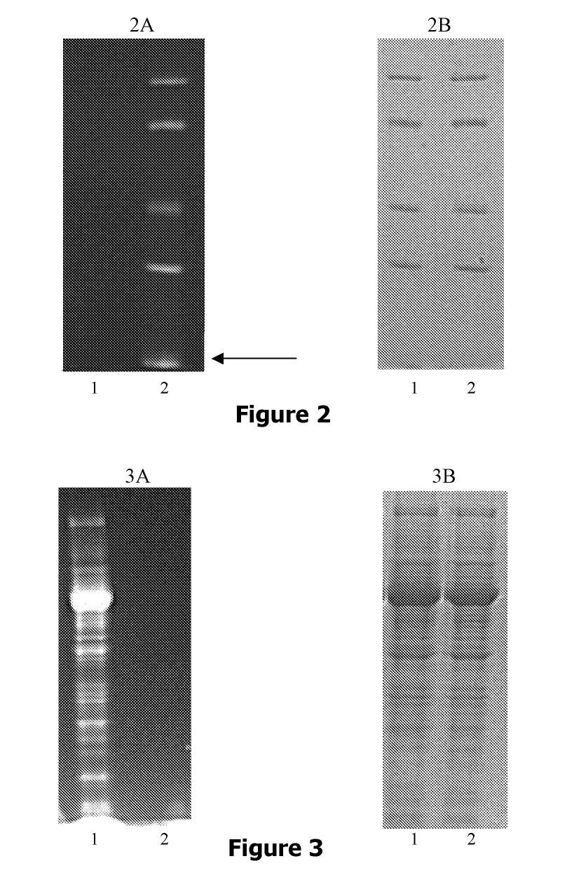

After electrophoresis, while still in the tank or gel cassette, the gel is placed on a UV trans-illuminator or a LED trans-illuminator to view the protein bands. Referring to FIG. 2, Image 2A is shown on the left side of page, which shows untreated proteins in Lane 1, Image 2A, and dye treated proteins of the invention in Lane 2, Image 2A. The arrow points to the un-conjugated dye molecules that have run to the front of the electrophoresis gel. Image 2B of FIG. 2 shows that the gel of Image 2A was subjected to Coomassie Blue staining techniques, whereby such staining was not affected by the fluorescence dyes conjugate on the proteins of the invention.

Example 3: In this example the Dye Solution A, Sample Treatment Buffer Solution B, and Protein Mixing Solution C are all the same as in the above-described Example 2. However, in this example the protein sample include a supernatant of E. Coli cell lysate with an over expressed protein. Referring to FIG. 3, as in the previous examples the processed gel was first viewed on an UV trans-illuminator (Image 3A of FIG. 3) and then stained by Coomassie Blue staining techniques (Image 3B of FIG. 3).

Again, after electrophoresis and while the gel is still in the tank or gel cassette, it is placed on a UV trans-illuminator or a LED trans-illuminator to view the protein bands. Referring to Image 3A of FIG. 3, Lane 1 shows the sample pretreated with a fluorescence dye solution according to the invention, and in Lane 2 images of the same sample that was not treated with a fluorescence dye. FIG. 3, Image 3B, shows that the gel of Image 3A subjected to Coomassie Blue staining techniques, whereby such staining was not affected by the fluorescence dyes conjugate on the proteins of the invention.

Example 4: This example is similar to that of Example 1; however, the fluorescence dye used was the fluorescein-type dye of 5/6-carboxyfluorescein succinimidyl ester (CAS No. 117548-22-8). This Dye Solution A was mixed with the Sample Treatment Buffer Solution B as described in Example 1 to form Protein Mixing Solution C. A supernatant of E. Coli cell lysate with an over expressed protein sample was mixed with the Protein Mixing Solution C in a ratio of 1:1 (by volume), and then heated at about 70° C.-100° C. for about 5-30 minutes.

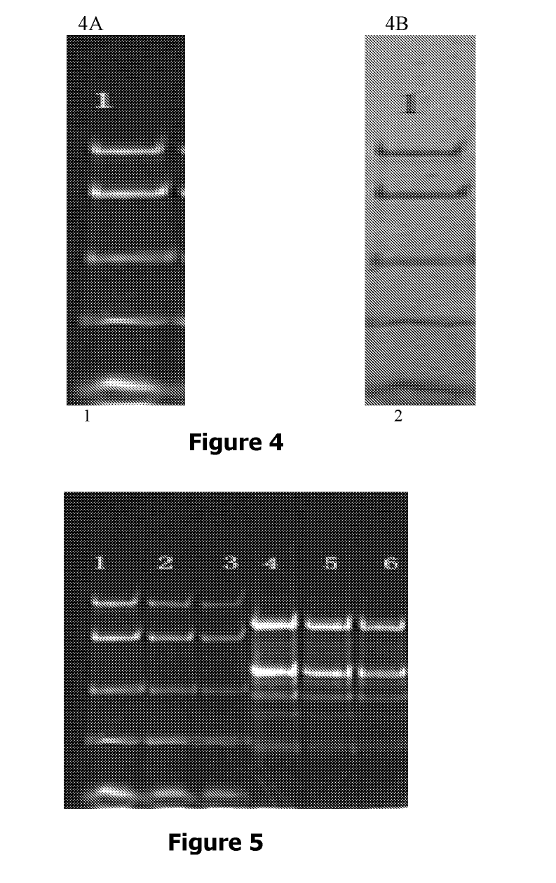

Desired amounts of dye treated protein sample were loaded into wells of an electrophoresis gel (e.g., an SDS-polyacrylamide gel), and the electrophoresis process performed according to common protocol. Referring to FIG. 4, Image 4A shows the dye treated proteins of the invention clearly visible on an UV trans-illuminator, while Image 4B of FIG. 4 shows the results of the gel shown in Image 4A stained by Coomassie Blue staining techniques. The results of FIG. 4B show that the fluorescence dyes conjugate on the proteins of the invention do not affect downstream processing after a gel has been run through an electrophoresis process.

Example 5: This example is similar to Example 2; however, the fluorescence dye used in this example is a Rhodamine-type dye comprising 5(6)-tetramethyl-rhodamine isothiocyanate mixed isomer, 5/6-TRITC, TMR (CAS No. 95197-95-8).

Sample wells 1-3 (shown in Lanes 1-3 of FIG. 5) were loaded with different volumes of different pretreated protein samples of the invention to be tested. The protein sample were supernatants of various mixed proteins. For example, the wells may be loaded with 5 μl, 10 μl and 15 μl of pretreated protein sample A, respectively, for lanes 1, 2 and 3.

Sample wells 4-6 (shown in Lanes 4-6 of FIG. 5) were loaded with different volumes of other pretreated protein samples of the invention. For instance, these wells 4-6 may be loaded with 5 μl, 10 μl and 15 μl of pretreated protein sample B. The results of Lanes 1-6 all show that the protein bands of the fluorescence dyed proteins of the invention are visible in the gel using UV and/or LED, while such gel still resides within the electrophoresis unit or gel cassette.

Example 6: Like that of Example 2, this Example also uses various supernatants of mixed proteins that have been treated with fluorescence dyes in accordance with the invention. In these examples the dye used is a Rhodamine-type dye, for example, Rhodamine B isothiocyanate (CAS No. 36877-69-7). In the Sample Treatment Buffer Solution B the buffer portion from example 2 was replaced by 200 mM phosphate buffer, pH 7.8 and glycerol was replaced by sucrose in the instant example.

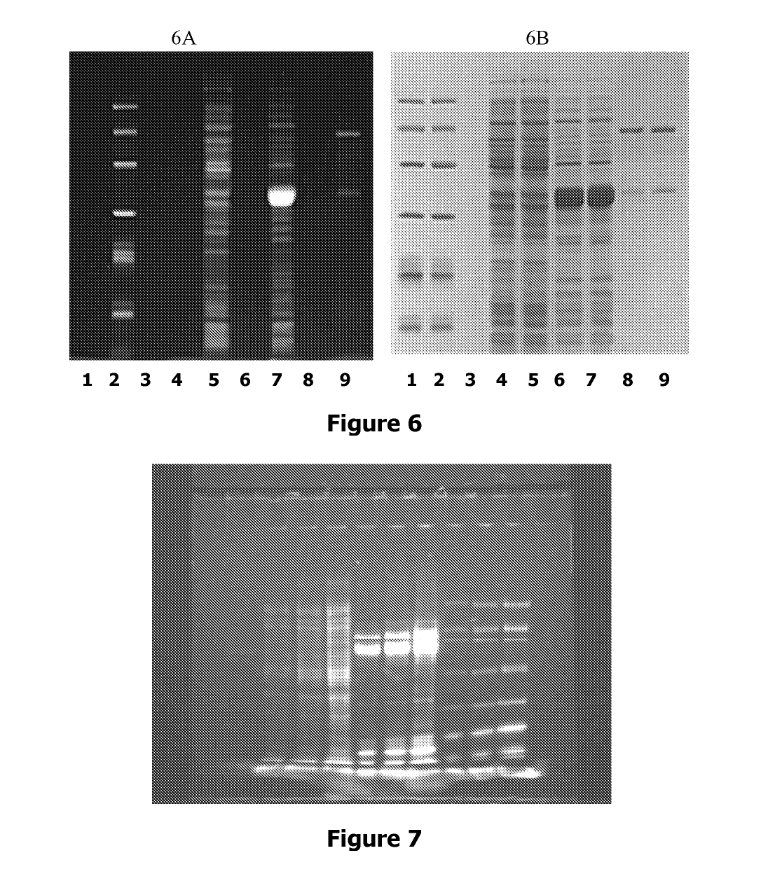

Referring to FIG. 6, FIG. 6A shows the electrophoresis run gel containing various different fluorescence dyed proteins therein in accordance with the invention. As is shown, Lane 1 shows the well containing no dye pretreated proteins, and Lane 2 shows this well containing a fluorescence dyed proteins. Lanes 3, 4, 6 and 8 also contain no dyed pretreated proteins, while Lanes 5, 7, and 9 contain different types of fluorescence dyed proteins in accordance with the invention. After the gel from FIG. 6A are viewed using UV and/or LED, such gel is further processed using Coomassie Blue staining techniques. As shown in the image of FIG. 6B, this staining and/or de-staining process was not affected by the fluorescence dyes conjugate on the different types of proteins sampled in this example.

Example 7: This example was processed that same as Example 2, and an image taken using an LED blue trans-illuminator. The image of FIG. 7 shows an electrophoresis run gel containing various protein samples of fluorescence dyed proteins of the invention that are imaged using LED while the gel still resides inside the gel cassette. The gel is viewed on the LED trans-illuminator. An advantage is that the protein bands can be seen without removing the gel from the gel cassette.

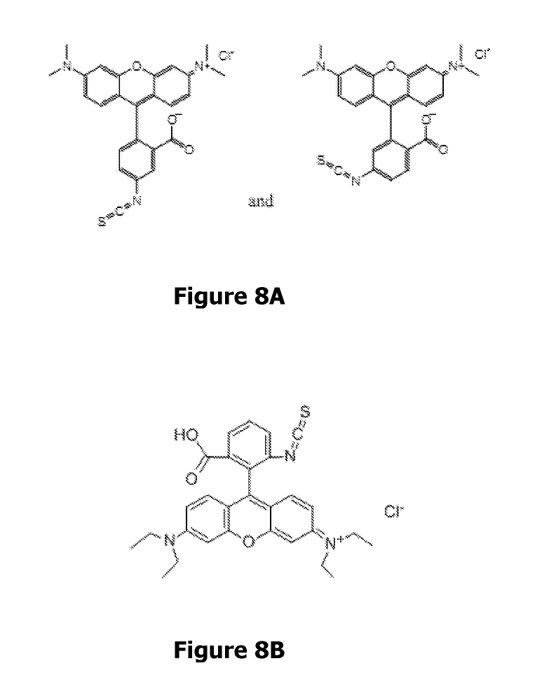

In accordance with the various embodiments of the invention described herein, it is shown in the examples and Figures that the fluorescence dyed proteins and methods of the invention are easy, fast and inexpensive. The instant fluorescence dyed proteins and methods also provide reliable test results as shown in the various examples described herein comparing the instant fluorescence dyed proteins viewed in a gel using UV/LED as compared to conventional more expensive, toxic and time consuming staining techniques of staining/de-staining using for, for instance, Coomassie Blue. While not meant to limit the invention, FIGS. 8A and 8B show exemplary structures of fluorescence dyes suitable for use in the present invention.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method for instantly viewing protein samples in an electrophoresis gel comprising:
providing a protein mixing solution containing a fluorescence dye mixed with a non-amine containing sample treatment buffer solution having a pH ranging from 7-11, the fluorescence dye selected from a fluorescein-type dye or a rhodamine-type dye;
generating a mixture containing fluorescence dyed proteins by mixing a protein sample with the protein mixing solution so that fluorescence dyes within the protein mixing solution conjugate to proteins within the protein sample;
heating the mixture containing fluorescence dyed proteins to a temperature ranging from 70° C. to 100° C. for a duration of 2-30 minutes to enhance conjugation of the fluorescence dyes in the protein mixing solution to the proteins in the protein sample;
prior to performing electrophoresis, providing a portion of the mixture containing fluorescence dyed proteins into a gel;
performing electrophoresis using said gel; and
directly viewing the fluorescence dyed proteins in the gel prior to removing the gel from a gel cassette in which the gel resides and prior to performing further processing steps on said gel.

2. The method of claim 1 wherein the is a fluorescein-type dye comprises 5(6)-fluorescein isothiocyanate mixed isomer or 5/6-carboxyfluorescein succinimidyl ester.

3. (canceled)

4. The method of claim 1 wherein the rhodamine-type dye comprises NES-Rhodamine; 5(6)-tetramethyl-rhodamine isothiocyanate mixed isomer, 5/6-TRITC, TMR; or Rhodamine B isothiocyanate.

5. (canceled)

6. The method of claim 1 wherein the fluorescence dye is selected from a combination of fluorescein-type dyes and rhodamine-type dyes.

7. The method of claim 6 wherein the fluorescence dye is selected from a combination of two or more of 5(6)-fluorescein isothiocyanate mixed isomer; 5/6-carboxyfluorescein succinimidyl ester; NHS-Rhodamine; 5(6)-tetramethyl-rhodamine isothiocyanate mixed isomer, 5/6-TRITC, TMR; and Rhodamine B isothiocyanate.

8-12. (canceled)

13. The method of claim 1 wherein the mixture comprises a fluorescence dye in an amount of 0.1 mg/ml to 20 mg/ml dissolved in an organic solvent of Dimethyl sulfoxide or Dimethylformamide.

14-18. (canceled)

19. The method of claim 1 wherein the sample treatment buffer solution includes a carbonate buffer, a Tris buffer, Hepes buffer, borate buffer, or a phosphate buffer.

20. (canceled)

21. The method of claim 1 wherein the sample treatment buffer solution comprises a non-amine containing buffer solution in combination with one or more of Dithiothreitol (DDT), Ethylenediaminetetraacetic acid (EDTA), Sodium dodecyl sulfate (SDS), Glycerol cesium chloride, poly(ethylene glycol) or Sucrose, and Bromophenol blue.

22. The method of claim 1 wherein the buffer solution comprises a 20-500 mM Tris-HCL buffer, 20-500 carbonate buffer, 20-500 mM borate buffer solution or 20-500 mM phosphate buffer solution, and has a pH ranging from 7 to 11.

23. The method of claim 22 wherein the sample treatment buffer solution further comprises 2-8% DDT, 0.1%-8% SDS, 0.1-0.5% EDTA, 4-50% cesium chloride, poly(ethylene glycol), glycerol or sucrose, and 0.02% Bromophenol blue.

24. (canceled)

25. (canceled)

26. The method of claim 1 wherein the protein mixing solution is provided by mixing the fluorescence dye solution with the sample treatment buffer solution in volume ratios ranging from 1:5 to 1:100.

27-29. (canceled)

30. The method of claim 1 wherein the protein sample is mixed with the protein mixing solution in volume ratios ranging from 1:1 to 1:10 to form the mixture containing fluorescence dyed proteins.

31. (canceled)

32. (canceled)

33. The method of claim 1 wherein the mixture containing fluorescence dyed proteins is provided into wells of the electrophoresis gel.

34. The method of claim 1 wherein the fluorescence dyed proteins are directly viewed in the gel using UV, fluorescence or LED transilluminator without removing the gel from the gel cassette in which the gel resides.

35-39. (canceled)

40. A method for instantly viewing proteins samples in an electrophoresis gel comprising:
providing a protein mixing solution containing a fluorescence dye solution and a sample treatment buffer solution,
the fluorescence dye solution comprising a mixture of
an organic solvent, and
a fluorescein-type dye or a rhodamine-type dye dissolved in the organic solvent in a concentration from 0.1 mg/ml to 20 mg/ml; and
the sample treatment buffer solution having a pH ranging from 7-11 comprising a mixture of,
a buffer solution selected from the group consisting of a borate buffer, a phosphate buffer, and a carbonate buffer,
Dithiothreitol (DDT),
Ethylenediaminetetraacetic acid (EDTA),
Sodium dodecyl sulfate (SDS), and
Cesium chloride, Poly(ethylene glycol), Glycerol or Sucrose;
generating a mixture containing fluorescence dyed proteins by mixing a protein sample with the protein mixing solution so that fluorescence dyes within the protein mixing solution conjugate to proteins within the protein sample
heating the mixture containing fluorescence dyed proteins to enhance conjugation of the fluorescence dyes in the protein mixing solution to the proteins in the protein sample;
prior to performing electrophoresis, providing a portion of the mixture containing fluorescence dyed proteins into a gel;
performing electrophoresis using said gel; and
directly viewing the fluorescence dyed proteins in the gel prior to removing the gel from a gel cassette in which the gel resides and prior to performing further processing steps on said gel.

41. The method of claim 40 wherein the fluorescence dye is selected from a fluorescein-type dye, a rhodamine-type dye or a combination thereof.

42-44. (canceled)

45. The method claim 40 wherein the organic solvent is Dimethyl sulfoxide or Dimethylformamide.

46-49. (canceled)

50. The method of claim 40 wherein the sample treatment buffer solution comprises a non-amine containing buffer solution in combination with one or more of Dithiothreitol (DDT), Ethylenediaminetetraacetic acid (EDTA), Sodium dodecyl sulfate (SDS), Glycerol or Sucrose, and Bromophenol blue.

51. The method of claim 40 wherein the buffer solution comprises a 20-500 mM borate buffer solution or 20-500 mM phosphate buffer solution, and has a pH ranging from 7 to 11.

52-57. (canceled)

58. A system for dying proteins for use in electrophoresis comprising:
a fluorescence dye solution comprising,
an organic solvent; and
a fluorescein-type dye or a rhodamine-type dye dissolved in the organic solvent in a concentration from 0.1 mg/ml to 20 mg/ml; and
a sample treatment buffer solution having a pH ranging from 7-11 comprising a mixture of,
a buffer solution selected from the group consisting of a borate buffer, a Tris-HCL, Hepes buffer phosphate buffer, and a carbonate buffer,
Dithiothreitol (DDT),
Ethylenediaminetetraacetic acid (EDTA),
Sodium dodecyl sulfate (SDS),
Glycerol or Sucrose;
a protein mixing solution comprising a mixture of the fluorescence dye solution and the sample treatment buffer solution in volume ratios ranging from 1:5 to 1:100;
a mixture of fluorescence dyed proteins formed by mixing the protein mixing solution with a protein sample and heating said mixture the fluorescence dyes to the proteins;
a gel cassette that receives a portion of the mixture of fluorescence dyed proteins therein;
a gel formed by the mixture of fluorescence dyed proteins within the gel cassette, whereby after electrophoresis using said gel the fluorescence dyed proteins are viewed directly within the gel cassette prior to removing the gel from said gel cassette.

59-75. (canceled)
